(19) United States
(12) Patent Application Publication
(10) Pub. No.: US 2019/0114236 A1
(43) Pub. Date: Apr. 18, 2019

(54) FAULT TOLERANT NETWORK ON-CHIP

(71) Applicant: ELECTRONICS AND TELECOMMUNICATIONS RESEARCH INSTITUTE, Daejeon (KR)

(72) Inventors: Jin Ho HAN, Seoul (KR); Min-Seok CHOI, Daejeon (KR); Young-Su KWON, Daejeon (KR)

(73) Assignee: ELECTRONICS AND TELECOMMUNICATIONS RESEARCH INSTITUTE, Daejeon (KR)

(21) Appl. No.: 16/022,334

(22) Filed: Jun. 28, 2018

(30) Foreign Application Priority Data
Oct. 12, 2017 (KR) 10-2017-0132859
Jun. 20, 2018 (KR) 10-2018-0071062

(51) Int. Cl. G06F 11/16; G06F 11/20; G06F 15/78

(52) U.S. Cl. CPC G06F 11/1666; G06F 15/7807; G06F 11/202

(57) ABSTRACT

A network on-chip may include a master circuit that outputs write data or receives read data, a slave circuit that stores the write data or outputs the read data, a master network interface circuit that generates a first error correction code associated with the write data, a slave network interface circuit that generates a second error correction code associated with the read data, and an on-chip network circuit that transmits the write data and the first error correction code to the slave network interface circuit or transmits the read data and the second error correction code to the master network interface circuit, the master network interface circuit decodes the read data and the second error correction code and requests the read data again or generates a first fault signal, and the slave network interface circuit decodes the write data and the first error correction code and requests the write data again or generates a second fault signal.

### CROSS-REFERENCE TO RELATED APPLICATIONS

This U.S. non-provisional patent application claims priority under 35 U.S.C. § 119 of Korean Patent Application Nos. 10-2017-0132859, filed on Oct. 12, 2017, and 10-2018-0071062, filed on Jun. 20, 2018, the entire contents of which are hereby incorporated by reference.

### BACKGROUND

The present disclosure herein relates to a network on-chip, and more particularly, to a fault tolerant network on-chip.

An integrated circuit implemented in a semiconductor device may include intellectual property (IP) having various functions. As the degree of integration of the integrated circuit is improved, the number of IPs integrated in the integrated circuit is increasing. A plurality of IPs integrated in an integrated circuit may be connected to each other through a bus. However, the bus has a fixed topology and lacks extensibility. Also, since the load on the bus may increase as the number of IPs connected to the bus increases, the communication speed between the IPs may decrease.

A network on chip (NoC) may be used to provide a path or channel with enhanced extensibility between a plurality of IPs and to increase the communication speed between the plurality of IPs. However, in addition to simply connecting a plurality of IPs, the NoC must be able to correct or recover errors that may occur in communication between the plurality of IPs. In addition, the NoC must be able to tolerate faults of internal IPs.

### SUMMARY

The present disclosure is to provide a fault tolerant network on-chip.

An embodiment of the inventive concept provides a network on-chip including: a master circuit configured to output write data or receive read data; a slave circuit configured to store the write data or output the read data; a master network interface circuit configured to generate a first error correction code associated with the write data; a slave network interface circuit configured to generate a second error correction code associated with the read data; and an on-chip network circuit configured to transmit the write data and the first error correction code to the slave network interface circuit or to transmit the read data and the second error correction code to the master network interface circuit, wherein the master network interface circuit is further configured to decode the read data and the second error correction code and to request the read data again or to generate a first fault signal, wherein the slave network interface circuit is further configured to decode the write data and the first error correction code and to request the write data again or to generate a second fault signal.

### BRIEF DESCRIPTION OF THE FIGURES

FIG. 1 illustrates a block diagram of a network on-chip according to an embodiment of the inventive concept;

FIG. 2 shows a block diagram of the master network interface circuit of FIG. 1 in more detail;

FIG. 3 shows a block diagram of the slave network interface circuit of FIG. 1 in more detail;

FIG. 4 is an exemplary flowchart illustrating operations of components of the NoC of FIG. 1 according to an embodiment;

FIG. 5 is an exemplary flowchart illustrating operations of components of the NoC of FIG. 1 according to another embodiment; and

FIG. 6 illustrates a block diagram of a network on-chip according to another embodiment of the inventive concept.

### DETAILED DESCRIPTION

In the following, embodiments of the inventive concept will be described in detail so that those skilled in the art easily carry out the inventive concept.

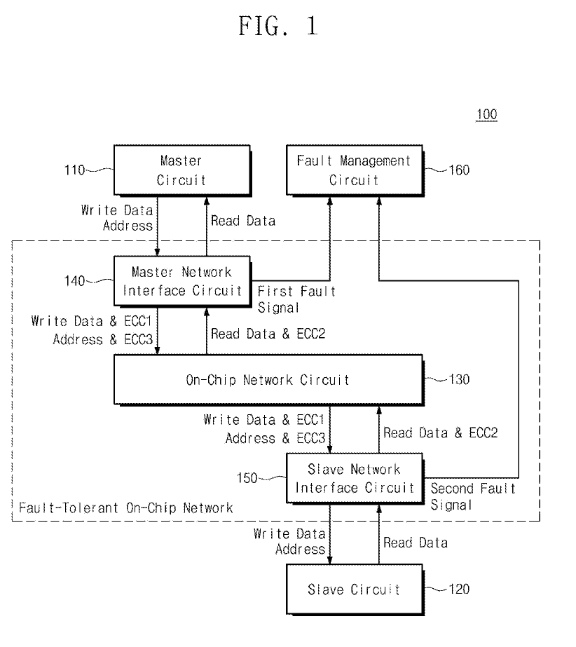

FIG. 1 illustrates a block diagram of a network on-chip according to an embodiment of the inventive concept. A network on-chip (NoC) 100 may be an integrated circuit implemented in a semiconductor device. For example, the NoC 100 may be referred to as a system-on-chip. The NoC 100 may include a master circuit 110, a slave circuit 120, an on-chip network circuit 130, a master network interface circuit 140, a slave network interface circuit 150, and a fault management circuit 160.

The master circuit 110 may control the overall operation of the NoC 100. The master circuit 110 may communicate with the slave circuit 120 through the on-chip network circuit 130. The master circuit 110 may output write data to be stored in the slave circuit 120 or may receive read data outputted from the slave circuit 120. The master circuit 110 may output an address together with write data. Here, the write data may be stored in the slave circuit 120 depending on the request of the master circuit 110, and the address may indicate the location of the slave circuit 120 in which the write data is stored. The read data may be outputted from the slave circuit 120 depending on the request of the master circuit 110.

For example, the master circuit 110 may be a processor. The master circuit 110 may include homogeneous multi-core processors or heterogeneous multi-core processors. The master circuit 110 may include at least one of a central processing unit (CPU), an image signal processing unit (ISP), a digital signal processing unit (DSP), a graphics processing unit (GPU), a vision processing unit (VPU), and a neural processing unit (NPU).

The slave circuit 120 may store write data or output read data at a location corresponding to an address under the control of the master circuit 110. For example, the slave circuit 120 may be a data storage. The slave circuit 120 may include a volatile memory such as a static random access memory (SRAM), a dynamic random access memory (DRAM), or the like. Alternatively, the slave circuit 120 may include a non-volatile memory such as a NAND flash memory, a NOR flash memory, a resistive random access memory (RRAM), a ferroelectric random access memory (FRAM), a phase change random access memory (PRAM), a thyristor random access memory (TRAM), a magnetic random access memory (MRAM), and the like. Alternatively, the slave circuit 120 may include a combination of volatile memory and non-volatile memory.

The on-chip network circuit 130 may provide paths, channels, or interconnection between the various components of the NoC 100 including the master circuit 110 and the slave circuit 120. Here, the components of the NoC 100 may be referred to as circuits, blocks, modules, units, intellectual property (IP), and the like. An advanced microcontroller bus architecture (AMBA) of the ARM (Advanced RISC machine) company for connecting the various circuits of the NoC 100 to the on-chip network circuit 130 may be implemented. For example, the on-chip network circuit 130 may support various protocols such as advanced system bus (ASB), an advanced peripheral bus (APB), an advanced high-performance bus (AHB), an advanced extensible interface (AXI), an advanced trace bus (ATB), an open core protocol (OCP), and the like.

The master network interface circuit 140 may connect the master circuit 110 and the on-chip network circuit 130. The master network interface circuit 140 may detect or recover an error that may occur in the communication between the master circuit 110 and the on-chip network circuit 130 or between the master circuit 110 and other circuits in the NoC 100. In addition, the master network interface circuit 140 may detect a fault of the circuit (e.g., a fault of the slave circuit 120 or the slave network interface circuit 150) of the NoC 100 communicating with the master circuit 110.

The master network interface circuit 140 may receive write data from the master circuit 110 and may generate a first error correction code ECC1 associated with the write data. The first error correction code ECC1 may be used to detect or correct an error in the write data. The master network interface circuit 140 may receive the read data and a second error correction code ECC2 from the on-chip network circuit 130 and may decode the read data and the second error correction code ECC2. The second error correction code ECC2 may be used to detect or correct an error in the read data. The master network interface circuit 140 may receive the address together with the write data from the master circuit 110 and may generate a third error correction code ECC3 associated with the address. The third error correction code ECC3 may be used to detect or correct an error in an address.

The master network interface circuit 140 may transmit the write data and the first error correction code ECC1 to the on-chip network circuit 130. The master network interface circuit 140 may transmit an address and a third error correction code ECC3 to the on-chip network circuit 130. The master network interface circuit 140 may transmit the read data to the master circuit 110 after decoding the read data and the second error correction code ECC2.

The master network interface circuit 140 may correct the error of the read data by decoding the second error correction code ECC2. The master network interface circuit 140 may request the read data to the slave network interface circuit 150 again if the error of the read data is uncorrectable. The master network interface circuit 140 may repeatedly request the read data to the slave network interface circuit 150 until the error of the read data is corrected. However, the master network interface circuit 140 may generate a first fault signal without requesting the read data again when the number of times of requesting read data again reaches the reference number. Here, the first fault signal may indicate that a fault occurs in the slave circuit 120 or the slave network interface circuit 150 communicating with the master circuit 110. The reference number may be a predetermined value or a variable value.

The slave network interface circuit 150 may connect the slave circuit 120 and the on-chip network circuit 130. The slave network interface circuit 150 may detect or recover an error that may occur in the communication between the slave circuit 120 and the on-chip network circuit 130 or between the slave circuit 120 and other circuits in the NoC 100. In addition, the slave network interface circuit 150 may also detect a fault of the circuit (e.g., the master circuit 110 or the master network interface circuit 140) of the NoC 100 communicating with the slave circuit 120.

The slave network interface circuit 150 may receive read data from the slave circuit 120 and may generate the second error correction code ECC2 associated with the read data. The slave network interface circuit 150 may transmit the read data and the second error correction code ECC2 to the master network interface circuit 140 through the on-chip network circuit 130.

The slave network interface circuit 150 may receive the write data and the first error correction code ECC1 from the on-chip network circuit 130 and may decode the write data and the first error correction code ECC1. After decoding, the slave network interface circuit 150 may transmit the write data to the slave circuit 120.

The slave network interface circuit 150 may correct the error of the write data by decoding the first error correction code ECC1. The slave network interface circuit 150 may request the write data to the master network interface circuit 140 again if the error of the write data is uncorrectable. The slave network interface circuit 150 may repeatedly request write data to the master network interface circuit 140 until the error of the write data is corrected. However, the slave network interface circuit 150 may generate a second fault signal without requesting the write data again when the number of times of requesting write data again reaches the reference number. Here, the second fault signal may indicate that a fault occurs in the master circuit 110 or the master network interface circuit 140 communicating with the slave circuit 120.

The slave network interface circuit 150 may correct the error of the address by decoding the third error correction code ECC3. The slave network interface circuit 150 may request the address to the master network interface circuit 140 again if the error of the address is uncorrectable. The slave network interface circuit 150 may repeatedly request the address to the master network interface circuit 140 until the error of the address is corrected. However, the slave network interface circuit 150 may generate the second fault signal without requesting the address again when the number of times of requesting the address again reaches the reference number.

The on-chip network circuit 130, the master network interface circuit 140, and the slave network interface circuit 150 may compose a fault tolerant on-chip network. According to an inventive concept embodiment, the circuits of the NoC 100 are not directly connected to the on-chip network circuit 130 but are connected to the on-chip network circuit 130 through a network interface circuit such as the master network interface circuit 140 or the slave network interface circuit 150. The master circuit 110 may be connected to the on-chip network circuit 130 through a dedicated network interface circuit (i.e., the master network interface circuit 140). The slave circuit 120 may be connected to the on-chip network circuit 130 through a dedicated network interface circuit (i.e., the slave network interface circuit 150). Another circuit of the NoC 100 not shown in FIG. 1 may be connected to the on-chip network circuit 130 through a dedicated network interface circuit.

The circuit of the NoC 100 according to an embodiment of the inventive concept may be connected to the on-chip network circuit 130 and another circuit through a dedicated network interface circuit. The dedicated network interface circuit may correct errors in the data received through the on-chip network circuit 130 or recover the error by requesting the data again if the error is uncorrectable. In addition, a dedicated network interface circuit may signal a fault in another circuit of the NoC 100 that generates data received through the on-chip network circuit 130.

The fault management circuit 160 may receive the first fault signal from the master network interface circuit 140 through the on-chip network circuit 130. The fault management circuit 160 may receive the second fault signal from the slave network interface circuit 150 through the on-chip network circuit 130. The fault management circuit 160 may determine whether or not a fault occurs in the master circuit 110, the slave circuit 120, the master network interface circuit 140, or the slave network interface circuit 150 based on the first and second fault signals.

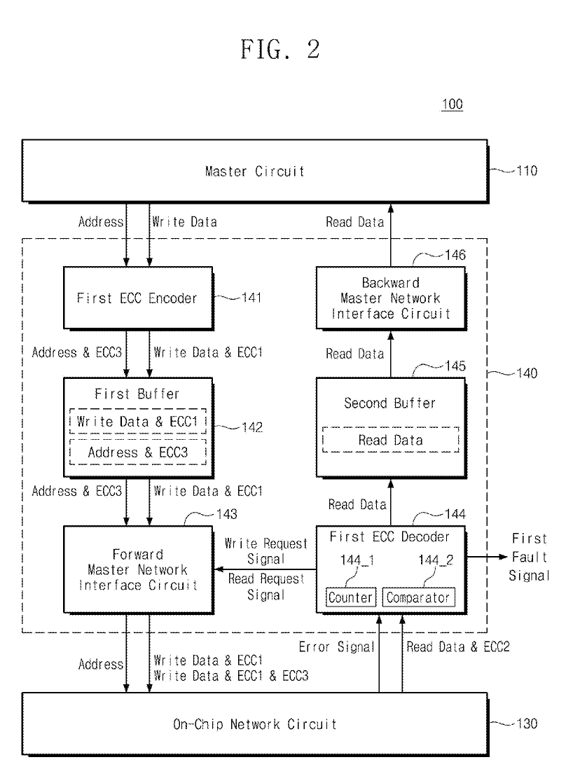

FIG. 2 shows a block diagram of the master network interface circuit of FIG. 1 in more detail. A master network interface circuit 140 may include a first ECC encoder 141, a first buffer 142, a forward master network interface circuit 143, a first ECC decoder 144, a second buffer 145, and a backward master network interface circuit 146. For convenience of illustration, the illustration of the other circuits 120, 150, and 160 of FIG. 1 is omitted.

The first ECC encoder 141 may encode the write data and generate the first error correction code ECC1. The first ECC encoder 141 may encode the address and generate the third error correction code ECC3. For example, the first ECC encoder 141 may perform encoding using various codes such as a Bose-Chaudhuri-Hocquenghem (BCH) code, a Reed-Solomon code, and the like. The first ECC encoder 141 may transmit the write data, the first error correction code ECC1, the address, and the third error correction code ECC3 to the first buffer 142.

The first buffer 142 may store write data, a first error correction code ECC1, an address, and a third error correction code ECC3. For example, the first buffer 142 may include a memory element such as a register, a latch, a flip-flop, or the like that stores each of the bits of the write data, the first error correction code ECC1, the address, and the third error correction code ECC3.

The forward master network interface circuit 143 may operate according to a protocol supported by the on-chip network circuit 130. The forward master network interface circuit 143 may transmit the address stored in the first buffer 142 to the on-chip network circuit 130. The forward master network interface circuit 143 may transmit the write data stored in the first buffer 142 and the first and third error correction codes ECC1 and ECC3. In the embodiment, when the master circuit 110 requests burst write for continuously writing data in an arbitrary address or address range, the forward master network interface circuit 143 may first transmit the write data, the address, and the first and third error correction codes ECC1 and ECC3, and then repeat and transmit the write data and the first error correction code ECC1.

Referring to FIG. 2, it is shown that the third error correction code ECC3 is transmitted to the on-chip network circuit 130 together with write data, not an address. For example, the on-chip network circuit 130 may support an address channel having a data width corresponding to the bits of the address and support a data channel having a data width corresponding to the bits of the data combined with the write data and the first and third error correction codes ECC1 and ECC3. Unlike FIG. 2, if the on-chip network circuit 130 supports a large address channel with a larger data width than the bits of the address, the forward master network interface circuit 143 may transmit the address and the third error correction code ECC3 together to the on-chip network circuit 130 through the address channel.

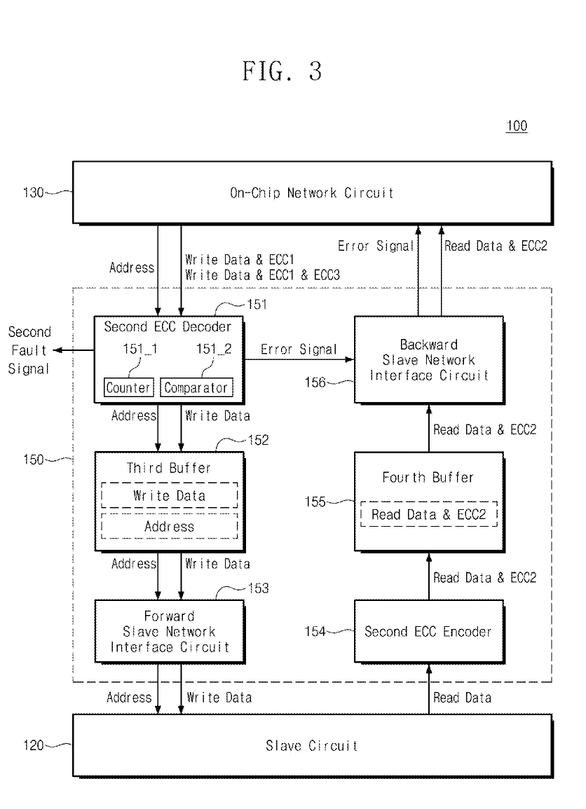

The forward master network interface circuit 143 may receive a write request signal and a read request signal from the first ECC decoder 144. The write request signal and the read request signal will be described later with reference to FIG. 3.

The first ECC decoder 144 may receive the read data and the second error correction code ECC2 from the on-chip network circuit 130 and may decode the read data and the second error correction code ECC2. The first ECC decoder 144 may perform decoding using various codes used in the second ECC encoder 154, which will be described later. The first ECC decoder 144 may perform decoding and transmit read data to the second buffer 145 if there is no error in the read data. The first ECC decoder 144 may correct the error of the read data through decoding and transmit the read data to the second buffer 145. If the detected error of the read data is uncorrectable through decoding, the first ECC decoder 144 may transmit a read request signal for requesting read data again to the forward master network interface circuit 143.

The first ECC decoder 144 may generate or activate the first fault signal when the number of times of requesting read data again reaches the reference number. For example, the first ECC decoder 144 may include a counter 144_1 for counting the number of times of requesting read data again, and the counter 144_1 may count the number of times that the uncorrectable error is detected by the first ECC decoder 144. The first ECC decoder 144 may include a comparator 144_2 for comparing the counted value of the counter 144_1 with the reference number.

The first ECC decoder 144 may further receive an error signal transmitted through the response channel from the on-chip network circuit 130 in addition to the read data and the second error correction code ECC2. The first ECC decoder 144 may transmit a write request signal for requesting write data or the address again to the forward master network interface circuit 143 based on the error signal.

The second buffer 145 may store read data transmitted from the first ECC decoder 144. Like the first buffer 142, the second buffer 145 may include a memory element such as a register, a latch, a flip-flops, etc., which stores each of the bits of the read data.

The backward master network interface circuit 146 may transmit the read data stored in the second buffer 145 to the master circuit 110. Here, there is no error in the read data stored in the second buffer 145 and transmitted from the backward master network interface circuit 146 to the master circuit 110. If the first ECC decoder 144 generates the first fault signal, the first ECC decoder 144 does not transmit the read data to the second buffer 145, the second buffer 145 does not store the read data, and the backward master network interface circuit 146 does not transmit the read data to the master circuit 110.

FIG. 3 shows a block diagram of the slave network interface circuit of FIG. 1 in more detail. A slave network interface circuit 150 may include a second ECC decoder 151, a third buffer 152, a forward slave network interface circuit 153, a second ECC encoder 154, a fourth buffer 155, and a backward slave network interface circuit 156. For convenience of illustration, the illustration of the other circuits 110, 140, and 160 of FIG. 1 is omitted.

The second ECC decoder 151 may receive the write data, the address, and the first and third error correction codes ECC1, ECC3 from the on-chip network circuit 130. The second ECC decoder 151 may decode the write data and the first error correction code ECC1. The second ECC decoder 151 may perform decoding and transmit the write data to the third buffer 152 if there is no error in the write data. The second ECC decoder 151 may correct the error of the write data and transmit the write data to the third buffer 152 through decoding. If the detected error of the write data is uncorrectable through decoding, the second ECC decoder 151 may transmit an error signal for requesting write data again to the backward slave network interface circuit 156.

The second ECC decoder 151 may decode the address and the third error correction code ECC3. The second ECC decoder 151 may perform decoding and transmit the address to the third buffer 152 if there is no error in the address. The second ECC decoder 151 may correct the error of the address through decoding and transmit the address to the third buffer 152. If the detected error of the address is uncorrectable through decoding, the second ECC decoder 151 may transmit an error signal for requesting an address again to the backward slave network interface circuit 156.

In an embodiment, the second ECC decoder 151 may generate or activate the same error signal if the write data is requested again or the address is requested again. In this case, if there is an uncorrectable error in either the write data or the address, the second ECC decoder 151 may receive again all of the write data, the address, and the first and third error correction codes ECC1 and ECC3. The first ECC decoder 144 of FIG. 2 may generate a write request signal that requests both write data and address again based on the error signal transmitted from the second ECC decoder 151 through the backward slave network interface circuit 156 and the on-chip network circuit 130.

In another embodiment, although not shown in the drawing, the second ECC decoder 151 may generate a first error signal that requests the write data again and a second error signal that requests the address again. The first ECC decoder 144 of FIG. 2 may receive each of the first and second error signals through the on-chip network circuit 130, generate a write request signal based on the first error signal, and generate an address request signal (not shown) based on the second error signal. If an uncorrectable error does not occur in the write data and an uncorrectable error occurs in the address, the second ECC decoder 151 may again receive only the address and the third error correction code ECC3. On the other hand, if an uncorrectable error does not occur in the address and an uncorrectable error occurs in the write data, the second ECC decoder 151 may receive only the write data and the first error correction code ECC1 again.

The second ECC decoder 151 may generate or activate the second fault signal when the number of times of requesting the write data or the address again reaches the reference number. For example, the second ECC decoder 151 may include a counter 151_1 for counting the number of times of requesting write data or an address again, and the counter 151_1 may count the number of times that the uncorrectable error is detected by the second ECC decoder 151. The second ECC decoder 151 may include a comparator 151_2 for comparing the counted value of the counter 151_1 with the reference number.

The third buffer 152 may store write data transmitted from the second ECC decoder 151. Like the first buffer 142 of FIG. 2, the third buffer 152 may include a memory element such as a register, a latch, a flip-flop, etc., which store each of the bits of the address and the write data.

The forward slave network interface circuit 153 may transmit the write data and the address stored in the third buffer 152 to the slave circuit 120. Here, there is no error in the write data and the address stored in the third buffer 152 and transmitted from the forward slave network interface circuit 153. If the second ECC decoder 151 generates the second fault signal, the second ECC decoder 151 does not transmit the write data and the address to the third buffer 152, the third buffer 152 does not store the write data and the address, and the forward slave network interface circuit 153 does not transmit the write data and the address to the slave circuit 120.

The second ECC encoder 154 may encode the read data outputted from the slave circuit 120 and generate the second error correction code ECC2. For example, the second ECC encoder 154 may perform encoding using the various codes described above. The second ECC encoder 154 may transmit the read data and the second error correction code ECC2 to the fourth buffer 155.

The fourth buffer 155 may store the read data and the second error correction code ECC2. For example, the fourth buffer 155 may include a memory element such as a register, a latch, a flip-flop, or the like that stores each of the bits of read data and the second error correction code ECC2.

The backward master network interface circuit 156 may operate according to a protocol supported by the on-chip network circuit 130. The backward slave network interface circuit 156 may transmit the read data and the second error correction code ECC2 stored in the fourth buffer 155 to the on-chip network circuit 130. The backward slave network interface circuit 156 may transmit an error signal indicating that an uncorrectable error occurs in the write data or the address to the on-chip network circuit 130. Although not shown in the drawing, the backward slave network interface circuit 156 may transmit a first error signal indicating that an uncorrectable error occurs in the write data and a second error signal indicating that an uncorrectable error occurs in the address, to the on-chip network circuit 130.

Referring to FIGS. 2 and 3, the forward master network interface circuit 143 may receive a write request signal and a read request signal from the first ECC decoder 144. Although not shown in the drawing, the forward master network interface circuit 143 may further receive an address request signal from the first ECC decoder 144. The read request signal may be generated in the first ECC decoder 144 according to the decoding result of the first ECC decoder 144. The write request signal may be generated in the first ECC decoder 144 according to an error signal or a first error signal generated according to the decoding result of the second ECC decoder 151. The address request signal may be generated in the first ECC decoder 144 according to an error signal or a second error signal generated according to the decoding result of the second ECC decoder 151.

The forward master network interface circuit 143 may receive the read request signal and request the read data and the second error correction code ECC2 to the slave network interface circuit 150 again. The forward master network interface circuit 143 receives the write request signal or the address request signal and transmits the write data stored in the first buffer 142 and the first error correction code ECC1 or the address and the third error correction code ECC3, to the slave network interface circuit 150 again. Alternatively, the forward master network interface circuit 143 may receive a write request signal or an address request signal and request write data or an address to the master circuit 110 again.

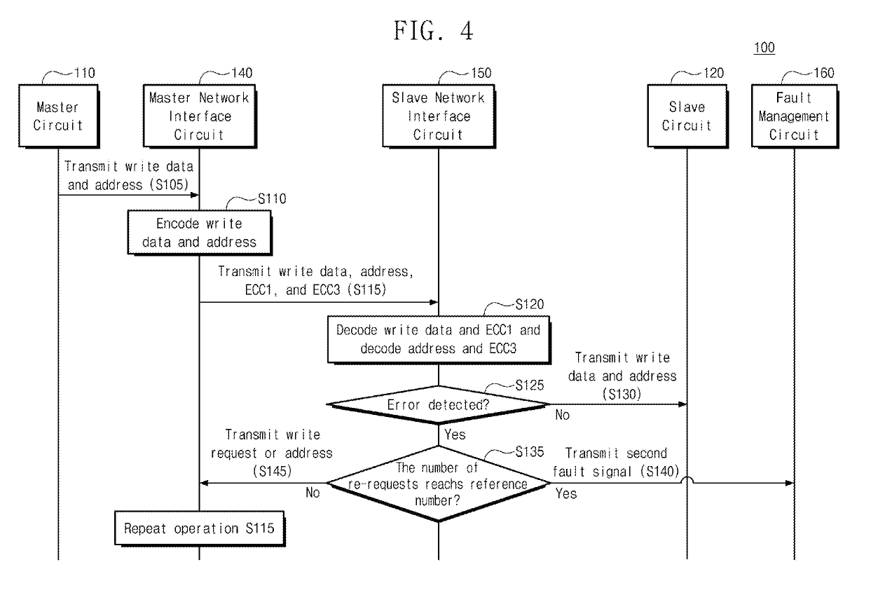

FIG. 4 is an exemplary flowchart illustrating operations of components of the NoC of FIG. 1 according to an embodiment. FIG. 4 will be described with reference to FIG. 1. Although the on-chip network circuit 130 of FIG. 1 is omitted in the NoC 100 of FIG. 4, communication between the master network interface circuit 140 and the slave network interface circuit 150 may be performed through the on-chip network circuit 130.

In operation S105, the master circuit 110 may transmit the write data and the address to be stored in the slave circuit 120 to the master network interface circuit 140. The master circuit 110 may access another circuit (e.g., the slave circuit 120) of the NoC 100 through the master network interface circuit 140. In operation S110, the master network interface circuit 140 may encode write data and an address respectively. The master network interface circuit 140 may generate a first error correction code ECC1 for correcting the error of the write data. The master network interface circuit 140 may generate a third error correction code ECC3 for correcting the error of the address. In operation S115, the master network interface circuit 140 may transmit the write data, the address, the first error correction code ECC1, and the third error correction code ECC3 to the slave network interface circuit 150.

In operation S120, the slave network interface circuit 150 may decode the write data and the first error correction code ECC1. The slave network interface circuit 150 may decode the address and the third error correction code ECC3. In operation S125, the slave network interface circuit 150 may detect an error in the write data or the address through decoding. In operation S130, the slave network interface circuit 150 may transmit the write data and the address to the slave circuit 120 if there is no error in the write data and the address or if the error is correctable. If there is an uncorrectable error in the write data or the address, operation S135 may be performed.

In operation S135, the slave network interface circuit 150 may determine whether the number of times of requesting the write data or the address again reaches the reference number. When the number of times of requesting the write data or the address again reaches the reference number, in operation S140, the slave network interface circuit 150 may transmit a second fault signal to the fault management circuit 160. When the number of times of requesting the write data or the address again does not reach the reference number, in operation S145, the slave network interface circuit 150 may transmit a write request or an address request to the master network interface circuit 140. The slave network interface circuit 150 may transmit an error signal for a write request or an address request to the master network interface circuit 140.

The master network interface circuit 140 may repeat operation S115 when receiving the error signal. The master network interface circuit 140 may repeat only operation S115 or operations S105, S110, and S115.

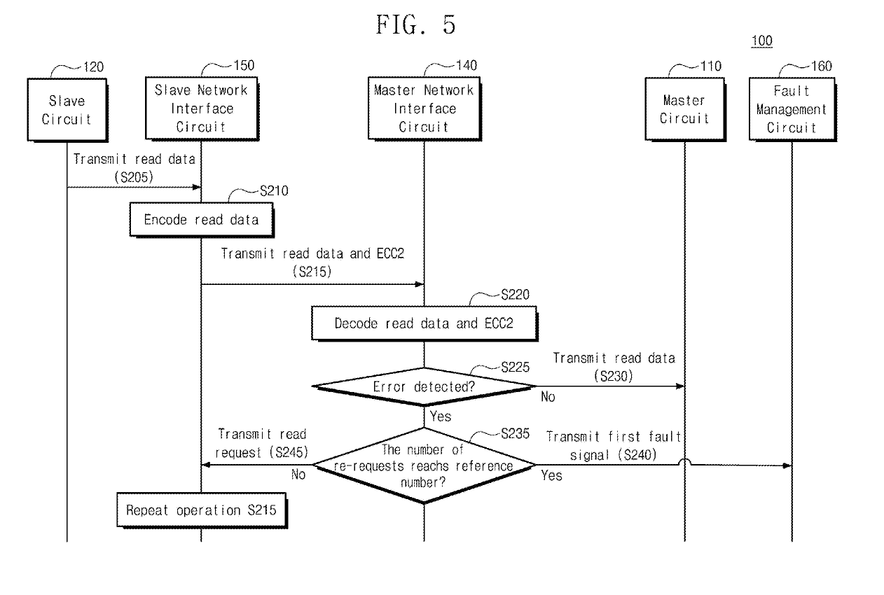

FIG. 5 is an exemplary flowchart illustrating operations of components of the NoC of FIG. 1 according to another embodiment. FIG. 5 will be described with reference to FIG. 1. Although the on-chip network circuit 130 of FIG. 1 is omitted in the NoC 100 of FIG. 5, communication between the slave network interface circuit 150 and the master network interface circuit 140 may be performed through the on-chip network circuit 130.

In operation S205, the slave circuit 120 may transmit the read data requested by the master circuit 110 to the slave network interface circuit 150. The slave circuit 120 may access another circuit (e.g., the master circuit 110) of the NoC 100 through the slave network interface circuit 150. In operation S210, the slave network interface circuit 150 may encode the read data. The slave network interface circuit 150 may generate a second error correction code ECC2 for correcting the error of the read data. In operation S215, the slave network interface circuit 150 may transmit the read data and the second error correction code ECC2 to the master network interface circuit 140.

In operation S220, the master network interface circuit 140 may decode the read data and the second error correction code ECC2. In operation S225, the master network interface circuit 140 may detect an error of the read data through decoding. In operation S230, the master network interface circuit 140 may transmit the read data to the master circuit 110 if there is no error in the read data or the error is correctable. If there is an uncorrectable error in the read data, operation S235 may be performed. In operation S235, the master network interface circuit 140 may determine whether the number of times of requesting the read data again reaches the reference number. When the number of times of requesting the read data again reaches the reference number, in operation S240, the master network interface circuit 140 may transmit a first fault signal to the fault management circuit 160. When the number of times of requesting the read data again does not reach the reference number, in operation S245, the master network interface circuit 140 may transmit a read request to the slave network interface circuit 150. The slave network interface circuit 150 may repeat operation S215 when receiving the read request. The slave network interface circuit 150 may repeat only operation S215, or operations S205, S210, and S215.

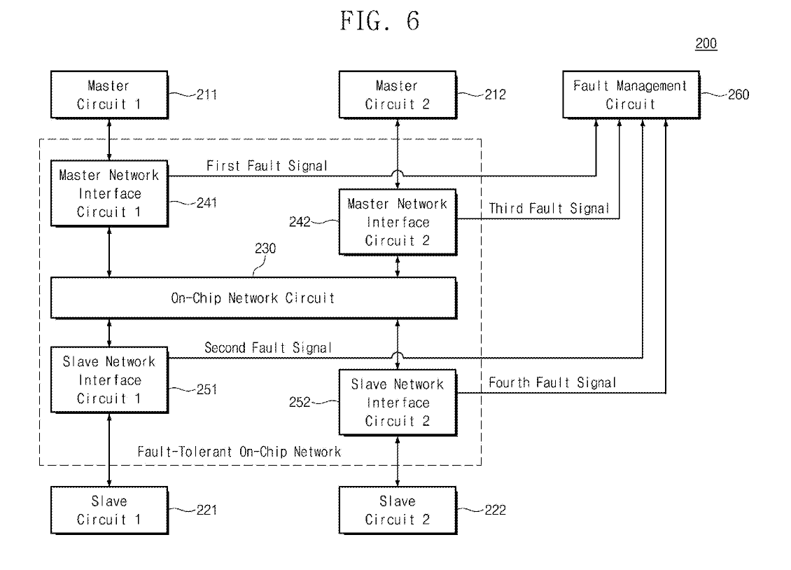

FIG. 6 illustrates a block diagram of an NoC according to another embodiment of the inventive concept. The NoC 100 of FIG. 1 includes one master circuit 110 and one slave circuit 120, but the number of master circuits and the number of slave circuits are not limited to those shown in FIG. 1. The NoC 200 may include a first master circuit 211, a second master circuit 212, a first slave circuit 221, a second slave circuit 222, an on-chip network circuit 230, a first master network interface circuit 241, a second master network interface circuit 242, a first slave network interface circuit 251, a second slave network interface circuit 252, and a fault management circuit 260.

Each of the first and second master circuits 211 and 212 may operate substantially the same as the master circuit 110 described above with reference to FIGS. 1 to 5. The on-chip network circuit 230 may operate substantially the same as the on-chip network circuit 130 described above with reference to FIGS. 1 to 5. Each of the first and second slave circuits 221 and 222 may operate substantially the same as the slave circuit 120 described above with reference to FIGS. 1 to 5.

The dedicated first master network interface circuit 241 of the first master circuit 211 may operate substantially the same as the master network interface circuit 140 described above with reference to FIGS. 1 to 5. The dedicated second master network interface circuit 242 of the second master circuit 212 may operate substantially the same as the master network interface circuit 140 described above with reference to FIGS. 1 to 5. The dedicated first slave network interface circuit 251 of the first slave circuit 221 may operate substantially the same as the slave network interface circuit 150 described above with reference to FIGS. 1 to 5. The dedicated second slave network interface circuit 252 of the second slave circuit 222 may operate substantially the same as the slave network interface circuit 150 described above with reference to FIGS. 1 to 5.

The fault management circuit 260 may receive the first to fourth fault signals from the first and second master network interface circuits 241 and 242 and the first and second slave network interface circuits 251 and 252. Based on the first to fourth fault signals, the fault management circuit 260 may determine whether there is a fault in the first and second master network circuits 211 and 212, the first and second master network interface circuits 241 and 242, the first and second slave circuits 221 and 222, and the slave network interface circuits 251 and 252. The fault management circuit 260 may operate the second slave circuit 222 instead of the first slave circuit 221 based on the first fault signal. The fault management circuit 260 may operate the second master circuit 212 instead of the first master circuit 211 based on the second fault signal. The fault management circuit 260 may operate the first slave circuit 221 instead of the second slave circuit 222 based on the third fault signal. The fault management circuit 260 may operate the first master circuit 211 instead of the second master circuit 212 based on the fourth fault signal.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A network on-chip comprising:
a master circuit configured to output write data or receive read data;
a slave circuit configured to store the write data or output the read data;
a master network interface circuit configured to generate a first error correction code associated with the write data;
a slave network interface circuit configured to generate a second error correction code associated with the read data; and
an on-chip network circuit configured to transmit the write data and the first error correction code to the slave network interface circuit or to transmit the read data and the second error correction code to the master network interface circuit,
wherein the master network interface circuit is further configured to decode the read data and the second error correction code and to request the read data again or to generate a first fault signal,
wherein the slave network interface circuit is further configured to decode the write data and the first error correction code and to request the write data again or to generate a second fault signal.

2. The network on-chip of claim 1,
wherein the master network interface circuit is further configured to correct an error in the read data by decoding a second error correction code, and
the slave network interface circuit is further configured to correct an error in the write data by decoding the first error correction code.

3. The network on-chip of claim 2,
wherein the master network interface circuit is further configured to request the read data again to the slave network interface circuit if the error in the read data is uncorrectable, and
the slave network interface circuit is further configured to request the write data again to the master network interface circuit if the error in the write data is uncorrectable.

4. The network on-chip of claim 3,
wherein the master network interface circuit is further configured to transmit the write data and the first error correction code to the slave network interface circuit depending on a request of the slave network interface circuit, and
the slave network interface circuit is further configured to transmit the read data and the second error correction code to the master network interface circuit depending on a request of the master network interface circuit.

5. The network on-chip of claim 4,
wherein the master network interface circuit is further configured to generate the first fault signal without requesting the read data again when a number of times of requesting the read data again reaches a reference number, and
the slave network interface circuit is further configured to generate the second fault signal without requesting the write data again when a number of times of requesting the write data again reaches the reference number.

6. The network on-chip of claim 5, wherein the reference number is a predetermined value or a variable value.

7. The network on-chip of claim 5, further comprising a fault management circuit configured to receive the first and second fault signals and to determine whether or not a fault occurs in the master circuit or the slave circuit based on the first and second fault signals.

8. The network on-chip of claim 7, further comprising:
a second master circuit configured to communicate with the on-chip network circuit in communication with the master circuit that is a first master circuit and the slave circuit that is a first slave circuit; and
a second slave circuit configured to communicate with the on-chip network circuit;
wherein the fault management circuit is further configured to operate the second slave circuit instead of the first slave circuit based on the first fault signal or to operate the second master circuit instead of the first master circuit based on the second fault signal.

9. The network on-chip of claim 1, wherein the master network interface circuit is further configured to receive an address together with the write data from the master circuit and generate a third error correction code associated with the address,
the on-chip network circuit is further configured to transmit the address and the third error correction code to the slave network interface circuit, and
the slave network interface circuit is further configured to decode the address and the third error correction code.

10. The network on-chip of claim 9, wherein the slave network interface circuit is further configured to correct an error in the address by decoding the third error correction code.

11. The network on-chip of claim 10, wherein the slave network interface circuit is further configured to request the address again to the master network interface circuit if the error in the address is uncorrectable.

12. The network on-chip of claim 11, wherein the master network interface circuit is further configured to transmit the address and the third error correction code to the slave network interface circuit depending on a request of the slave network interface circuit.

13. The network on-chip of claim 11, wherein the slave network interface circuit is further configured to generate the second fault signal without requesting the address again when a number of times of requesting the address again reaches a reference number.

14. The network on-chip of claim 13, wherein the master network interface circuit comprises:
a first encoder configured to encode the write data and the address transmitted from the master circuit and to generate the first and third error correction codes;
a first buffer configured to store the write data, the address, and the first and third error correction codes transmitted from the first encoder;
a forward master network interface circuit configured to transmit the write data, the address, and the first and third error correction codes stored in the first buffer to the on-chip network circuit;
a first decoder configured to decode the read data and the second error correction code transmitted from the on-chip network circuit;
a second buffer configured to store the read data transmitted from the first decoder; and
a backward master network interface circuit configured to transmit the read data stored in the second buffer to the master circuit.

15. The network on-chip of claim 14, wherein the first decoder is further configured to store the read data in the second buffer, to transmit a read request signal for requesting the read data again to the forward master network interface circuit, or to generate the first fault signal, based on decoding results of the read data and the second error correction code.

16. The network on-chip of claim 15, wherein the slave network interface circuit comprises:
a second decoder configured to decode the write data and the first error correction code and to decode the address and the third error correction code;
a third buffer configured to store the write data and the address transmitted from the second decoder;
a forward slave interface circuit configured to transmit the write data and the address stored in the third buffer to the slave circuit;
a second encoder configured to encode the read data transmitted from the slave circuit and to generate the second error correction code;
a fourth buffer configured to store the read data and the second error correction code transmitted from the second encoder; and
a backward slave network interface circuit configured to transmit the read data and the second error correction code stored in the fourth buffer to the on-chip network circuit.

17. The network on-chip of claim 16, wherein the second decoder is further configured to store the write data in the third buffer, to transmit an error signal for requesting the write data again to the backward slave network interface circuit, or to generate the second fault signal, based on decoding results of the write data and the first error correction code.

18. The network on-chip of claim 17, wherein the backward slave network interface circuit is further configured to transmit the error signal to the on-chip network circuit, and
the first decoder of the master network interface circuit is further configured to transmit a write request signal for requesting the write data again to the forward master network interface circuit based on the error signal transmitted from the on-chip network circuit.

19. The network on-chip of claim 16, wherein the second decoder is configured to store the address in the third buffer, to transmit an error signal for requesting the address again to the backward slave network interface circuit, or to generate the second fault signal, based on decoding results of the address and the third error correction code.

20. The network on-chip of claim 17, wherein the backward slave network interface circuit is further configured to transmit the error signal to the on-chip network circuit, and
the first decoder of the master network interface circuit is further configured to transmit an address request signal for requesting the address again to the forward master network interface circuit based on the error signal transmitted from the on-chip network circuit.
